(19) United States
(12) Patent Application Publication
(10) Pub. No.: US 2017/0262898 A1
(43) Pub. Date: Sep. 14, 2017

(54) Automated Selection Of User/Message Combinations

(71) Applicant: Amplero, Inc., Seattle, WA (US)

(72) Inventors: Jesse S. Hersch, Seattle, WA (US); Oliver B. Downs, Seattle, WA (US); Luca Cazzanti, Seattle, WA (US)

(21) Appl. No.: 15/607,273

(22) Filed: May 26, 2017

Related U.S. Application Data
(63) Continuation of application No. 14/264,634, filed on Apr. 29, 2014, now abandoned.

(51) Int. Cl. G06Q 30/02; G06K 9/62; G06N 99/00; G06N 7/00

(52) U.S. Cl. CPC G06Q 30/0271; G06N 7/005; G06K 9/6282; G06N 99/005

(57) ABSTRACT

Techniques train a tree to identify offers to send to a particular customer. Messages that include offers and having attributes are sent to a target user group. Feature measure results from the messages on the target user group, is used with feature measure results for a control user group, to train the tree with branch splits being identified based on maximizing an information gain from the feature measure results for a message/user attribute, where each node within the tree includes target and control distributions for the feature measure. The tree is traversed for a given marketing message/user, drawing randomly from feature measure distributions in the tree to determine whether to send the given marketing message to the user. By drawing randomly from the feature measure distributions, exploration and exploitation of various messages may be performed to minimize ignoring of messages that may have an information gain for particular customers.

### TECHNICAL FIELD

The present invention relates generally to deciding marketing messages having offers to send to a particular customer (user) and, more particularly, but not exclusively to training a tree with branch splits being identified based on maximizing an information gain for a message/user attribute, where each node within the tree includes target and control distributions for a feature measure, the trained tree then being traversed for multiple potential message/user combinations, drawing randomly from feature measure distributions in the tree to determine which user/message combinations to send.

### BACKGROUND

The dynamics in today's telecommunications market are placing more pressure than ever on networked services providers to find new ways to compete. With high penetration rates and many services nearing commoditization, many companies have recognized that it is more important than ever to find new ways to bring the full and unique value of the network to their customers. In particular, these companies are seeking new solutions to help them more effectively up-sell and/or cross-sell their products, services, content, and applications, successfully launch new products, and create long-term value in new business models.

One traditional approach for marketing a particular product or service to telecommunications customers includes broadcasting a variety of generic offerings to customers to see which ones are popular. The popular offers may then be sent en mass to all their customers. However, providing these mass marketing product offerings to a customer may significantly reduce the likelihood that the product will be purchased. It may also result in marketing overload for a customer. Other traditional approaches include performing various types of analysis on their customer data to try to better understand a customer's needs. However, many such analytical approaches tend to provide an offering to customers long after the offering is no longer relevant.

Moreover, there is a desire by many telecommunication providers to deepen their engagement with their customers, and provide an improved customer experience. They seek to increase the value that their customers receive, and to extend their long term value. By doing so, it is expected that such actions may increase customer loyalty, and thereby result in increased revenue. Therefore many vendors continue to seek better approaches to marketing their products to their customers that include addressing the changing market. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which the techniques may be practiced;

FIG. 2 shows one embodiment of a client device that may be included in a system implementing the techniques;

FIG. 3 shows one embodiment of a network device that may be included in a system implementing the techniques;

FIG. 4 shows one embodiment of a contextual marketing architecture employing automatic marketing offer decisioning;

FIG. 5 shows one embodiment of a flow diagram of a process for creating/training a tree with feature measure distributions on nodes;

FIG. 6 shows one embodiment of a flow diagram of a process usable for creating the tree with feature measure distributions;

FIG. 7 shows one embodiment of a flow diagram of a process for using the trained tree of FIG. 5 to perform automated marketing offer decisioning; and

FIGS. 8-9 illustrate non-limiting, non-exhaustive examples of subsets of trees with different feature measure distributions.

### DETAILED DESCRIPTION

The present techniques now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The various occurrences of the phrase “in one embodiment” as used herein do not necessarily refer to the same embodiment, though they may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “customer,” “user,” and “subscriber” may be used interchangeably to refer to an entity that has or is predicted to in the future make a procurement of a product, service, content, and/or application from another entity. As such, customers include not just an individual but also businesses, organizations, or the like. Further, as used herein, the term “entity” refers to a customer, subscriber, user, or the like.

As used herein, the terms “networked services provider”, “telecommunications”, “telecom”, “provider”, “carrier”, and “operator” may be used interchangeably to refer to a provider of any network-based telecommunications media, product, service, content, and/or application, whether inclusive of or independent of the physical transport medium that may be employed by the telecommunications media, products, services, content, and/or application. As used herein, references to “products/services,” or the like, are intended to include products, services, content, and/or applications, and is not to be construed as being limited to merely “products and/or services.” Further, such references may also include scripts, or the like.

As used herein, the terms “optimized” and “optimal” refer to a solution that is determined to provide a result that is considered closest to a defined criteria or boundary given one or more constraints to the solution. Thus, a solution is considered optimal if it provides the most favorable or desirable result, under some restriction, compared to other determined solutions. An optimal solution therefore, is a solution selected from a set of determined solutions.

As used herein the term “entropy” refers to a degree of randomness or lack of predictability in an effect of an attribute being evaluated, or based on some other action.

As used herein, the terms “offer” and “offering” refer to a networked services provider's product, service, content, and/or application for purchase by a customer. An offer or offering may be presented to the customer (user) using any of a variety of mechanisms. Thus, the offer or offering may be independent of the mechanism by which the offer or offering is presented.

As used herein, the term “message” refers to a mechanism for transmitting an offer or offering. Typically, the offer or offering is embedded within a message having a variety of attributes. The attributes may include how the message is presented, when the message is presented, or the like. Thus, in some embodiments, an attribute of a message having the offer may include the mechanism in which the offer is presented. For example, in some embodiments, a message having the offer may be selected to be sent to a user/customer based on an attribute of how the offer is presented (e.g., voice, IM, email, or the like), or when it is presented.

Moreover, because the offer may have various attributes, those offer attributes may be grouped and collectively herein referred to as message attributes, as well. For example, the offer may include a discount attribute, a tone of voice attribute, an urgency attribute, or the like, each of which may be collectively assigned as attributes of the message (which includes the offer and its attributes).

As used herein, the term “tree” refers to an undirected graph in which any two vertices are connected by one simple path. Thus, for example, in one embodiment, a tree may be a binary tree, a ternary tree, or the like; however, other tree structures may be used. As used herein, the term “node” may also refer to a leaf, where a leaf is the special case of a node, having a degree of one.

As used here, the term “feature measure” refers to an outcome or result of an action (or non-action) for which a marketer may wish to observe and/or otherwise influence based on some input. For example, a marketer may wish to determine whether offering a discount on some product results in an increase in purchases. In this non-exhaustive, non-limiting example, the feature measure would be purchases. However, marketers may also like to influence a variety of other feature measures, including, but not limited to Average Revenue Per User (ARPU), Active Base Percentage (ABP), Average Revenue Per Paying User (ARPPU), average margin per user (AMPU), or a variety of other outcomes.

As used herein, the terms “target,” and “target group,” refer to a composition of users that are subjected to some action for which a resulting feature measure is to be observed. The target group may sometimes be referred to as a “test group.” A “target distribution,” then may be a graph or representation of a feature measure result for the target group. Similarly, the terms “control,” and “control group,” refer to a composition of users do not receive the action that the target group is subjected to. A “control distribution,” then may be a graph or other representation of the feature measure result for the control group.

The following briefly describes the embodiments in order to provide a basic understanding of some aspects of the techniques. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are disclosed herein that are directed towards automatically training a tree usable to identify marketing offers to send to a particular customer. Messages (that include offers) having a plurality of attributes are sent to a target user group, and feature measure results from the messages on the target user group are used together with feature measure results for a related control user group, to train the tree where branch splits inside the tree are identified based on maximizing an information gain from the feature measure results for a message/user attribute, and each node within the tree includes target and control distributions for the feature measure for the associated attribute.

While messages used to train the tree may be created to include a variety of attributes, it is noted that each user in both the target and control user groups also has a variety of user attributes. Examples of message attributes, include, but are not limited to, a message content (e.g., the offer); an urgency of a message; a method in which the message is communicated to a user, such as email, Instant Messaging (IM), voice mail (VM), or the like; a tone of the message; a time of day, week, month, and/or year, in which the message is sent or for which an offer is intended; or any of a variety of other attributes. User attributes, include, but are not limited to, an user's age; a geographic location of the user; an income status of the user; a usage plan; a plan identifier (ID); a refresh rate for the plan; a user propensity (e.g., a propensity to perform an action, or so forth) or the like. Attributes may also include or otherwise represent information about user clusters, including recharge (of a mobile device) time series clusters, usage histogram clusters, cluster scoring, or the like. Thus, attributes may include a variety of information about users and/or messages. In some embodiments, the attributes may have discrete values, continuous values, values constituting a category, cyclical values, or the like. In some embodiments, a user and/or message may not include at least one attribute (missing attribute) for which another user/message might include. Thus, as disclosed below, in training the tree, pre-processing of at least some of the attributes might be performed. The set of attributes from the messages and user groups, along with a feature measure may be used to create attribute vectors with feature measure results, which may then be used to train the tree.

Any of a variety of feature measures for which a marketer may wish to optimize may be selected for creating the tree, including, but not limited to an Average Revenue Per User (ARPU), Active Base Percentage (ABP), or the like. As disclosed further below, multiple trees may be trained where each tree includes branches that are directed towards maximizing a respective, different, feature measure. A weighted combination of the trees data may then be used where a marketer has an interest in optimizing marketing offer decisions over several feature measures. Moreover, a sliding window in which messages are sent and feature measure results obtained, may be used so as to capture market changes in patterns of users over time.

During a run-time process, the trained tree is then traversed for a given message/user (attribute vector), drawing randomly from the feature measure distributions at the appropriate leaf in the tree to determine whether to send the given message to the given user. By drawing randomly from the feature measure distributions, exploration and exploitation of various messages may be performed to minimize ignoring of messages that may have an information gain for particular customers.

It is further noted that while a tree structure is described herein one embodiment of a model useable to maximize an information gain for a message or user attribute, other models may also be used. Thus, other embodiments of the innovations disclosed herein may include other models including, but not limited to logistic regression models, neural networks, support vector machine regression models, Gaussian Process models, General Bayesian model, and so forth.

It is noted that while embodiments herein disclose applications to telecommunications customers, where the customers are different from the telecommunications providers, other intermediate entities may also benefit from the subject innovations disclosed herein. For example, banking industries, cable television industries, retailers, wholesalers, or virtually any other industry in which that industry's customers interact with the services and/or products offered by an entity within that industry.

### Illustrative Operating Environment

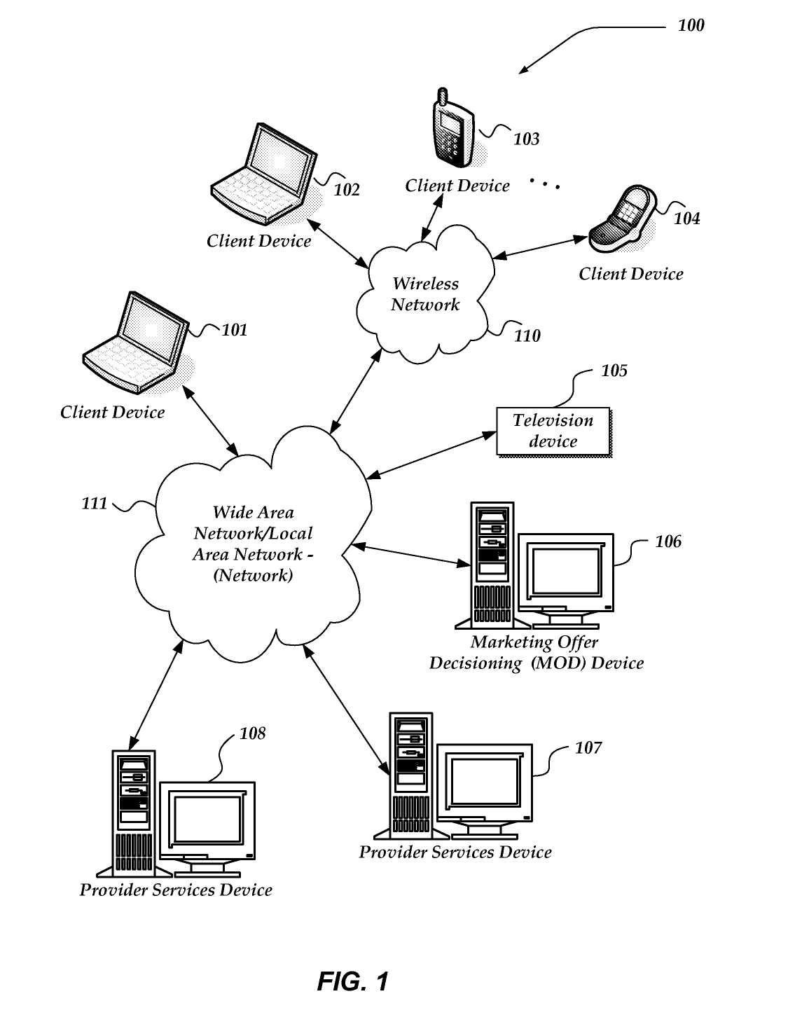

FIG. 1 shows components of one embodiment of an environment in which the invention may be practiced. Not all the components may be required to practice the invention, and variations in the arrangement and type of the components may be made without departing from the spirit or scope of the subject innovations. As shown, system 100 of FIG. 1 includes local area networks (“LANs”)/wide area networks (“WANs”)-(network) 111, wireless network 110, client devices 101-105, Marketing Offer Decisioning (MOD) device 106, and provider services 107-108.

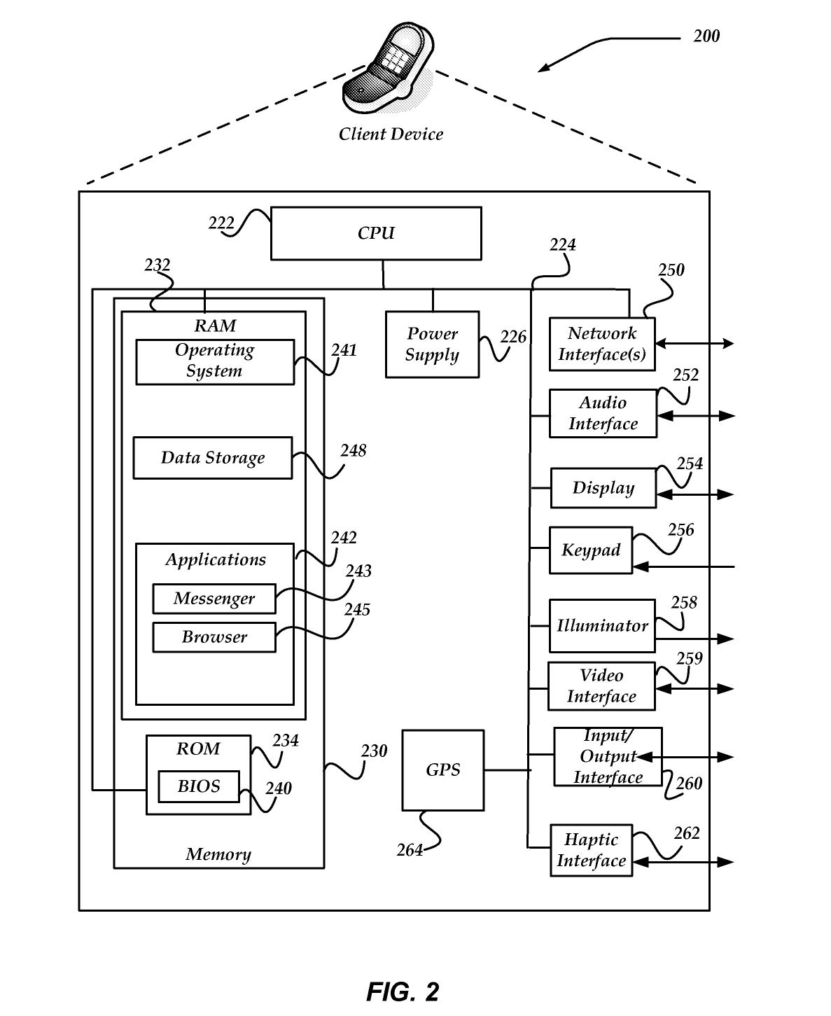

One embodiment of a client device usable as one of client devices 101-105 is described in more detail below in conjunction with FIG. 2. Generally, however, client devices 102-104 may include virtually any computing device capable of receiving and sending a message over a network, such as wireless network 110, wired networks, satellite networks, virtual networks, or the like. Such devices include wireless devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as telephones, televisions, video recorders, cable boxes, gaming consoles, personal computers, multiprocessor systems, microprocessor-based or programmable consumer electronics, network PCs, or the like. Further, as illustrated, client device 105 represents one embodiment of a client device operable as a television device. In one embodiment, client device 105 may also be portable. In one embodiment, one or more of client devices 101-105 may also be configured to operate over a wired and/or a wireless network.

Client devices 101-105 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-105 also may include at least one other client application that is configured to receive information and other data from another computing device. The client application may include a capability to provide and receive textual content, multimedia information, audio information, or the like. The client application may further provide information that identifies itself, including a type, capability, name, or the like. In one embodiment, client devices 101-105 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

In one embodiment, client devices 101-105 may further provide information useable to detect a location of the client device. Such information may be provided in a message, or sent as a separate message to another computing device.

Client devices 101-105 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-105 may further be configured to include a client application that enables the user to log into a user account that may be managed by another computing device. Information provided either as part of a user account generation, a purchase, or other activity may result in providing various customer profile information. Such customer profile information may include, but is not limited to purchase history, current telecommunication plans about a customer, and/or behavioral information about a customer and/or a customer's activities.

Wireless network 110 is configured to couple client devices 102-104 with network 111. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. Further, wireless network 110 may be configured to enable use of a short message service center (SMSC) as a network element in a mobile telephone network, within wireless network 110. Thus, wireless network 110 enables the storage, forwarding, conversion, and delivery of SMS messages. In essence, wireless network 110 may include virtually any wireless communication mechanism by which information may travel between client devices 102-104 and another computing device, network, or the like.

Network 111 couples MOD device 106, provider service devices 107-108, and client devices 101 and 105 with other computing devices, and allows communications through wireless network 110 to client devices 102-104. Network 111 is enabled to employ any form of computer readable media for communicating information from one electronic device to another. Also, network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 111 includes any communication method by which information may travel between computing devices.

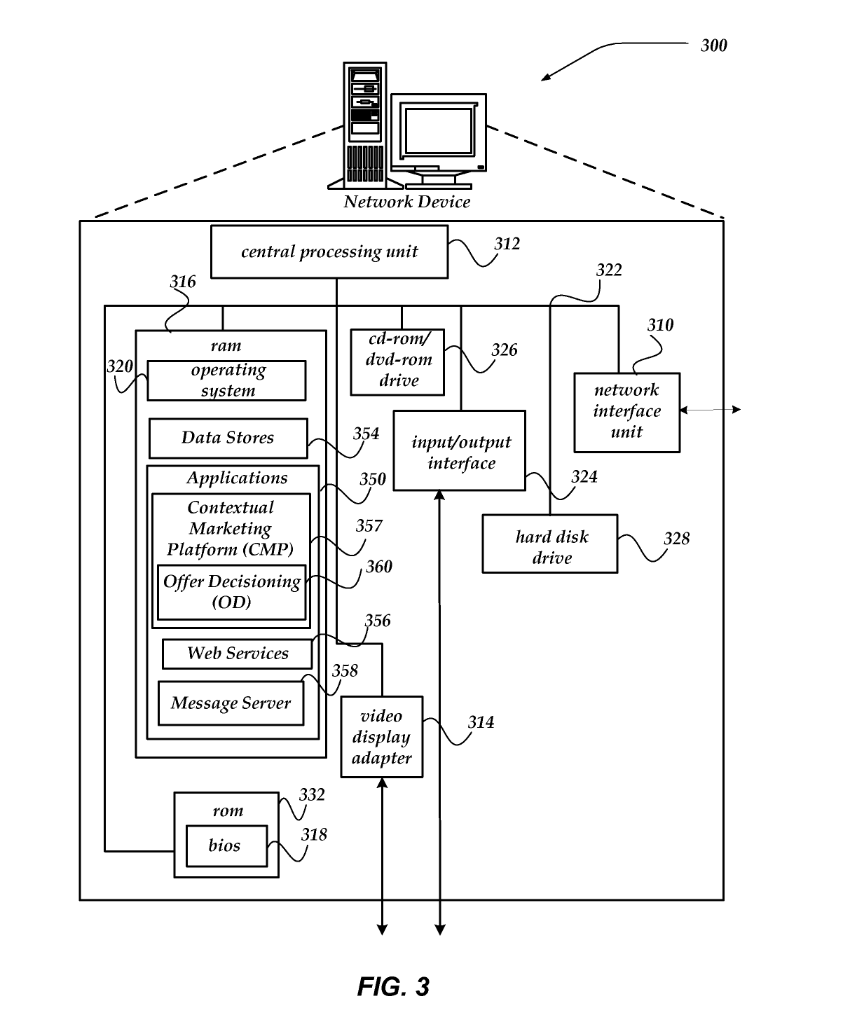

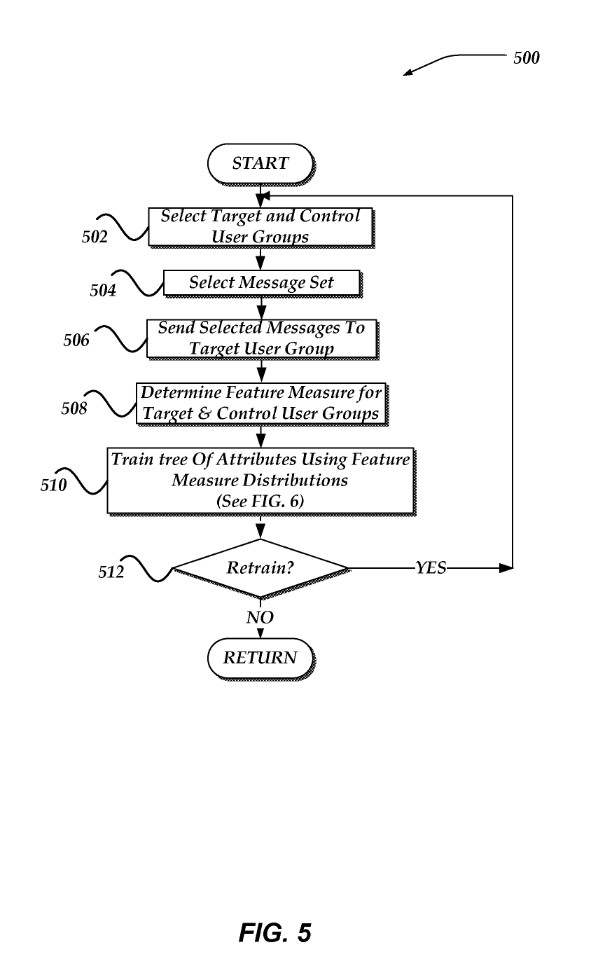

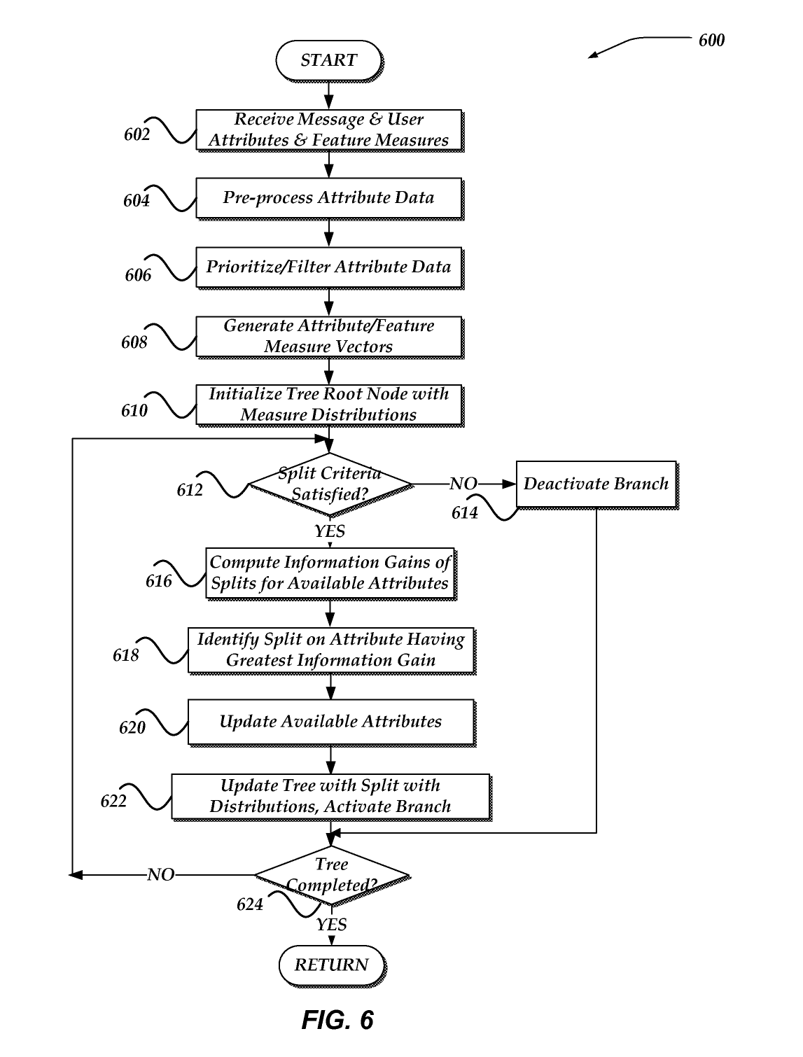

One embodiment of an MOD device 106 is described in more detail below in conjunction with FIG. 3. Briefly, however, MOD device 106 includes virtually any network computing device that is configured to proactively and contextually target offers to customers based on use of tree with branch splits being identified based on maximizing an information gain for a message/user attribute, and where each node within the tree includes target and control distributions for a feature measure as described in more detail below in conjunction with FIGS. 5-6.

Devices that may operate as MOD device 106 include, but are not limited to personal computers, desktop computers, multiprocessor systems, microprocessor-based or programmable consumer electronics, network PCs, servers, network appliances, and the like.

Although MOD device 106 is illustrated as a distinct network device, the invention is not so limited. For example, a plurality of network devices may be configured to perform the operational aspects of MOD device 106. For example, data collection might be performed by one or more set of network devices, while training of the tree and use of the trained tree might be provided by one or more other network devices.

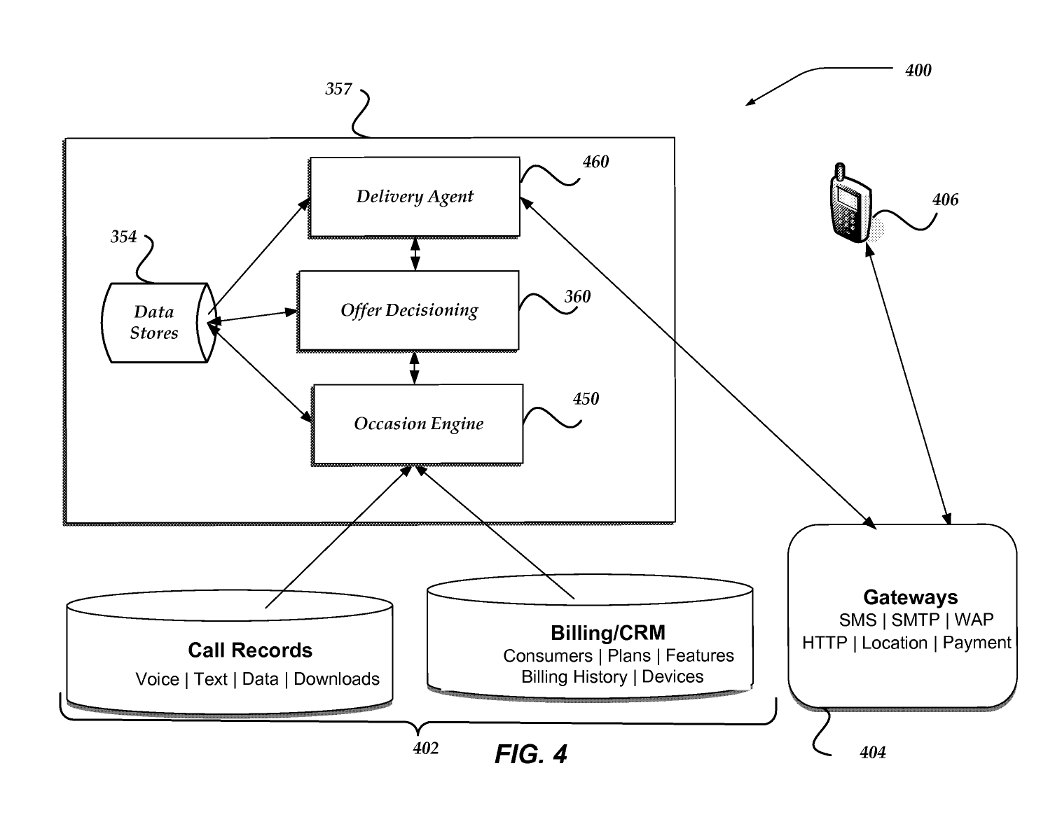

Provider service devices 107-108 include virtually any network computing device that is configured to provide to MOD device 106 information including networked services provider information, customer information, and/or other context information for use in generating and selectively presenting a customer with targeted customer offers based on use of the tree and its associated feature measure distributions. In some embodiments, provider service devices 107-108 may provide various interfaces, including, but not limited to those described in more detail below in conjunction with FIG. 4.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-105 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client operating system, for example, such as Windows Mobile™, PlayStation 3 System Software, the Symbian® operating system, Android, Blackberry, iOS, or the like. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, purchase history information, user demographic information, behavioral information, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols. Messenger 243, browser 245, or other communication mechanisms that may be employed by a user of client device 200 to receive selectively targeted offers of a product/service based on a tree generated and used based on one or more feature measure distributions with a tree structure.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, MOD device 106 of FIG. 1.

Network device 300 includes central processing unit (CPU) 312 (as shown, CPU 312 may include one or more processors), video display adapter 314, and a mass memory, all in communication with each other via bus 322. The mass memory generally includes RAM 316, ROM 332, and one or more permanent (non-transitory) mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable device, namely computer storage devices. Computer readable storage devices may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory, physical devices which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, information about members to a social networking activity, contact lists, identifiers, profile information, tags, labels, and any of a variety of attributes associated with a user or message, as well as scripts, applications, applets, and the like.

One or more applications 350 may be loaded into mass memory and run on operating system 320 using CPU 312. Examples of application programs may include transcoders, schedulers, calendars, database programs, word processing programs, HTTP programs, customizable user interface programs, IPSec applications, encryption programs, security programs, VPN programs, web servers, account management, games, media streaming or multicasting, and so forth. Applications 350 may include web services 356, Message Server (MS) 358, and Contextual Marketing Platform (CMP) 357. As shown, CMP 357 includes Offer Decisioning (OD) 360.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 might interact with CMP 357 to enable a networked services provider to track customer behavior, and/or provide contextual offerings based on feature measure distributions within a tree of message/user attributes.

Message server 358 may include virtually any computing component or components configured and arranged to forward messages from message user agents, and/or other message servers, or to deliver messages to a local message store, such as data store 354, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, Session Initiation Protocol (SIP), or the like.

However, message server 358 is not constrained to email messages, and other messaging protocols may also be managed by one or more components of message server 358. Thus, message server 358 may also be configured to manage Short Message Service (SMS) messages, IM, MMS, IRC, mIRC, or any of a variety of other message types. In one embodiment, message server 358 may also be configured to interact with CMP 357 and/or web services 356 to provide various communication and/or other interfaces useable to receive provider, customer, and/or other information useable to determine and/or provide contextual customer offers.

However, it should be noted that messages may be provided to a customer service call center, where the messages may be outbound communicated to a customer, for example, by a human, or be integrated into an inbound conversation between a customer and an agent. The messages, may, for example, be a display advertising message shown on a service provider's customer portal, or in a user's browser on their client device. Moreover, messages may also be sent using any of a variety of protocols to the client device, including, but not limited, for example, via Unstructured Supplementary Service Data (USSD).

One embodiment of CMP 357 and OD 360 are described further below in conjunction with FIG. 4. However, briefly, CMP 357 is configured to receive various historical data from networked services providers about their customers, including customer profiles, billing records, usage data, purchase data, types of mobile devices, and the like. CMP 357 may then perform analysis including offer decisioning, using OD 360. In one embodiment, CMP 357 employs feature measure distributions within a tree of message/user attributes to identify a market offering to provide to a particular customer.

CMP 357 employs OD 360 to repeatedly train/re-train one or more trees based on sending of selective messages to a selected target group of users to obtain one or more different feature measure results. Vectors of message and user attributes, along with feature measure results, are employed by OD 360 to identify branch splits within the trees that maximize an information gain for the feature measure results. The sending of the selective messages may be performed using a sliding time window so as to capture changes in market patterns over time. The trained trees may then be used to randomly draw from feature measure distributions within the tree to determine an ordered list of messages for a given user. The ordered list of messages may then be used by CMP 357 to determine which message(s) to send to a particular user. It is noted that because a given message may include attributes concerned with when and/or how a message might be sent to a user, CMP 357 may further use such information to optimize a presentation of the message to the user. CMP 357 and OD 360 may employ processes as described in more detail below in conjunction with FIGS. 5-7.

Illustrative Architecture

FIG. 4 shows one embodiment of an architecture useable to perform marketing of contextual offers to be delivered to a customer based on an ordered list of messages for a given customer (user), the ordering being generated by random selections from feature measure distributions within a trained tree of message/user attributes that includes feature measure distributions. Architecture 400 of FIG. 4 may include many more components than those shown. The components shown, however, are sufficient to disclose an illustrative embodiment for practicing the invention. Architecture 400 may be deployed across components of FIG. 1, including, for example, MOD device 106, client devices 101-105, and/or provider services 107-108.

Architecture 400 is configured to make selection decisions from trained trees having feature measure distributions. An ordered message list is identified for each user based on the randomly drawing from feature measure distributions from within the trained tree(s) for each message/user attribute vector.

Not all the components shown in FIG. 4 may be required to practice the invention and variations in the arrangement and type of the components may be made without departing from the spirit or scope of the subject innovation. As shown, however, architecture 400 includes a CMP 357, networked services provider (NSP) data stores 402, communication channel or communication channels 404, and client device 406.

Client device 406 represents a client device, such as client devices 101-105 described above in conjunction with FIGS. 1-2. NSP data stores 402 may be implemented within one or more services 107-108 of FIG. 1. As shown, NSP data stores 402 may include a Billing/Customer Relationship Management (CRM) data store, and a Network Usage Records data store. However, the subject innovation is not limited to this information, and other types of data from networked services providers may also be used. The Billing/CRM data may be configured to provide such historical data as a customer's profile, including their billing history, customer service plan information, service subscriptions, feature information, content purchases, client device characteristics, and the like. Usage Records may provide various historical data including but not limited to network usage record information including voice, text, internet, download information, media access, and the like. NSP data stores 402 may also provide information about a time when such communications occur, as well as a physical location for which a customer might be connected to during a communication, and information about the entity to which a customer is connecting. Such physical location information may be determined using a variety of mechanisms, including for example, identifying a cellular station that a customer is connected to during the communication. From such connection location information, an approximate geographic or relative location of the customer may be determined.

CMP 357 is streamlined for occasion identification and presentation. Only a small percentage of the massive amount of incoming data might be processed immediately. The remaining records may be processed from a buffer to take advantage of processing power efficiently over a period of time. As the raw data is processed into vectors of attributes, trees, distribution data, and other supporting data, the raw data, and/or results of the processing on the raw data may be stored for later use.

Communication channels 404 include one or more components that are configured to enable network devices to deliver and receive interactive communications with a customer. In one embodiment, communication channels 404 may be implemented within one or more of provider services 107-108, and/or client devices 101-105 of FIG. 1, and/or within networks 110 and/or 111 of FIG. 1.

The various components of CMP 357 are described further below. Briefly, however, CMP 357 is configured to receive customer data from NSP data stores 402. CMP 357 may then employ Offer Decisioning (OD) 360 to conduct studies usable to train/re-train one or more trees with branch splits being identified based on maximizing an information gain for a message/user attribute, and each node within the tree includes target and control distributions for a feature measure. Then, a plurality of messages attribute vectors may be identified for each user that is eligible for the plurality of messages. The generated message/user attribute vectors are then used to traverse the one or more trees, and to use the feature measure distributions within the tree to determine a sampled expected feature measure lift of sending that user a particular message. An ordered list of the plurality of messages is generated based on the lift, and is used to determine which message(s) to send to the user.

Delivery Agent 460 may be used to send messages to a one or more users based on the directions of OD 360, both during training of the tree(s), as well as during run-time when the tree(s) are employed to generate the ordered list of messages for users.

### Generalized Operation

The operation of certain additional general aspects of the subject innovation will now be described with respect to FIGS. 5-9. FIG. 5 shows one embodiment of a flow diagram of a process for creating a tree with feature measure distributions on nodes that may be used to perform automated marketing offer decisioning. Process 500 of FIG. 5 may be performed using one or more processors within MOD device 106 of FIG. 1.

Process 500 may begin, after a start block, at block 502, where a first group of users is selected in which to use as a target group for sending training messages. A second group of users is also selected as a control group of users. As a general rule, membership in a group is exclusive, in that a user is not in both groups. Moreover, a user that is selected as a member of a target group for one experiment might remain in a target group for subsequent studies, at least for a period of time. Moreover, so as to minimize possible cross-experiment impacts, studies might be separated in time for a user, so that an affect of one message may decay sufficiently to minimize its affect on results of a subsequent experiment.

In one embodiment, the initial size of each group of users is selected to avoid an operational difficulty that might arise when market offer campaigns are based on very narrow segments of a user population. Thus, it is desirable that the groups are initially selected to be fairly large. Generally, many telecommunications service providers may have millions, if not tens of millions of customers. Therefore, it may not be unreasonable to conduct an experiment to create the tree based on initial sample sizes in the millions, and terminating a branch test, as discussed below, when a subset sample size is less than 1000, or so. However, other sizes may also be used, based for example, on a desired confidence level for hypothesis testing (e.g., Type I/Type II errors), or the like.

Moving next to block 504, a set of initial training messages is selected. In one non-limiting, non-exhaustive example, it might be desired to determine a value of sending market offerings that have an urgent purchase content, over different times of a day/week/month, using different mechanisms to send the message such as IM, email, VM, or the like. Other message attributes might also be of interest for training the tree(s). Thus, the message set may be selected by varying any of a variety of message attributes that may be of initial interest to a marketer.

Moving to block 506, the selected messages may then be sent to the target user group over a period of time. For example, because it might be desirable to see if a time of week is relevant to a receptivity of a message, the message might be sent at different times of a week to the target user group. Other criteria might also be used to determine when and/or how a message is sent to the target user group. It is noted that the control user group does not receive the selected messages. In this way, the effects of receiving the selected messages may be compared to not receiving the selected messages, all other parameters being known to be consistent between the target and control user groups.

Flowing next to block 508, at least one feature measure is selected for recording of both the target user group and the control user group as a result of sending the selected messages at block 506. For example, it might be desired to determine whether the message has an impact on an ARPU feature measure, or an ABP feature measure, or a data consumption feature measure or the like. In some embodiments a plurality of feature measures may be of interest. Thus, data is collected for the one or more feature measure(s) of interest based on the sending (or not sending) of the message set. Again, such data may be collected over a sliding time window. The width or duration of the window may be set based on characteristics of the offer, the feature measure, the aggregate behavior customers of the telecommunications provider on the client devices, a usage behavior, and/or a combination of these or other characteristics. In one embodiment, the width/duration of the window might be one month, and the width/duration slides by one week. However, other values may also be used.

From block 508, process 500 then flows to block 510, which is described in more detail below in conjunction with FIG. 6. Briefly, however, the data collected for the target and control user groups and the feature measure results are provided to block 510 for use in training a tree that has branch splits identified as maximizing an information gain for a message/user attribute, each node within the tree further including target and control distributions for a feature measure.

Further, at block 508, a model definition for the tree along with its associated target and control distributions may then be stored in a modeling metadata store, such as within data stores 354 of FIG. 3, for example. However, other data stores may also be used, including data stores located elsewhere.

Processing then flows to decision block 512, where a determination is made whether to re-train the tree (or even to train a new tree on a different feature measure). If one or more trees are to be trained/re-trained, processing branches back to block 502; otherwise, processing may return to a calling process.

As noted above, FIG. 6 shows one embodiment of a flow diagram of a process usable for creating the tree with feature measure distributions usable at run-time. Process 600 of FIG. 6 may represent one process usable within block 508 of FIG. 5.

Briefly, process 600 of FIG. 6 employs an approach sometimes referred to as A/B testing, hypothesis testing, or split testing, in which randomized experiments with two variants, A and B, are performed to determine an impact on some feature measure of a user's behavior. As messages and users have a plurality of attributes, a plurality of evaluations are performed based on the sending of the messages to then create a tree of branch splits based on those attributes (message or user) that indicate a greatest information gain.

Briefly, an information gain Gₙ at any node n of the tree may be defined as a difference between an overall entropy Hₙ(R) at the node and an entropy conditioned on a candidate attribute Ai at that node Hₙ(R|A), or:

Gₙ(Aᵢ)=Hₙ(R)−Hₙ(R|Aᵢ),

where n=0, 1, 2, . . . N−1; R is the feature measure lift random variable of interest, such as ARPU. A similar formulation holds for the feature measure ABP lift, as discussed later.

The information gain is directed towards measuring how much the overall entropy decreases when it is known that attribute Aᵢ takes on a specific value Aᵢ=aᵢⱼ, or is limited to a given range of values, Aᵢ≦aᵢⱼ. The information gain therefore measures attribute Aᵢ's contribution to the randomness of the data. If assigning a value or range to Aᵢ decreases the overall entropy the most, then attribute Aᵢ and its split point value aᵢⱼ should be selected at a given node of the tree. Process 600 then may be employed to evaluate the information gain Gₙ for each candidate attribute to determine split value candidates in creating the tree.

Therefore, process 600 begins at block 602, after a start block, where the message and user attributes and feature measure results of the sending of the messages are received. In one embodiment, each user is uniquely identified, in addition to their user attributes, as being in either the control group (and not receiving the messages), or in the target group (and having received the messages).

Processing flows next to block 604, where pre-processing of at least some of the attribute data for the messages and/or users may be performed, so as to enable binary testing and computing of conditional entropies. Some attributes might be described as categorical attributes. These attributes might take on discrete values, which can be strings or non-ordinal numerical values. That is, the attribute might take on different values based on being in some category. For example, a plan ID attribute might be a non-ordinal numerical attribute, because, say, plan 101 is different from plan 202. However, there is no notion, in this example, where plan 202 is greater than plan 101. Further, there might not be a single attribute category usable, absent pre-processing, in A/B testing approaches. Similarly, balance time series cluster ID is a non-ordinal numerical attribute, because cluster 3 and cluster 7 are different, but there is again no notion of a sorted order for the cluster IDs. Therefore, pre-processing categorical attributes for possible splits, may include the enumeration of the unique values the attribute can take on. For example, for attribute Aᵢ, the split evaluations may be based on {aᵢ₁, aᵢ₂, . . . }, where aᵢⱼ represents values of the attribute Aᵢ.

Then, later in process 600, the information gain for each given value aᵢⱼ of a candidate categorical attribute Aᵢ may be determined as:

Gₙ(aᵢⱼ)=Hₙ(R)−[w₁Hₙ(R|Aᵢ=aᵢⱼ)+w₂Hₙ(R|Aᵢ≠aᵢⱼ)].

where weights w₁ and w₂ assigned to the entropies are the proportions of samples at node n for which the condition Aᵢ=aᵢⱼ is true or false (or some other binary values) respectively, so that the expression in the square brackets above is the weighted average entropy due to conditioning attribute A.

Pre-processing may also be performed for discrete, ordinal attributes that take on discrete numerical values that carry a notion of order. For example, deciles are ordered in that if a subscriber (user) is in a top 10% of SMS users, then the subscriber is definitely in the top 20% of SMS users. Thus, split points may be determined below based on the natural discrete values of the attribute. However, there are several choices on how to pre-process the attribute data to condition the entropy to compute the information gain. One option might be to ignore ordering and treat discrete, ordinal attributes as categorical attributes. Another approach, shown herein, considers ordering. In this approach, the information gain may be determined as:

Gₙ(aᵢⱼ)=Hₙ(R)−[w₁Hₙ(R|Aᵢ≦aᵢⱼ)+w₂Hₙ(R|Aᵢ>aᵢⱼ)]

Another type of attributes that might be pre-processed includes continuous numerical attributes. These attributes may be able to take on any numerical value. For these attributes the challenge is to determine the split points such that the resulting entropy calculations retain discriminative power while being computationally feasible. Exhaustively iterating through all possible values of the attribute may not be an option however.

Several strategies are available for optimal attribute splitting including a non-parametric approach that uses quantiles. The range of possible values taken on by an attribute is divided into quantiles, and each quantile value is then usable as a possible split point. The information gain for this approach is then similar to the above case for discrete, ordinal attributes.

Further, a number of quantiles might be determined using a variety of mechanisms, such as using deciles, semi-deciles, quartiles, or the like. In some instances, a characteristic of a given attribute might indicate a selection of an optimal quantization. In some embodiments, the quantizations might be re-computed at each tree node level. However, in other instances, a fixed quantization might be used based on unsplit attributes.

Upon completion of block 604, process 600 flows next to block 606, where at least some attributes may be filtered out, or otherwise prioritized based on the testing being conducted, a characteristic of an attribute, or the like. For example, if the tree is being constructed for a particular geographic location, then having an attribute based on other geographic locations, might be of little interest. Such attribute could then be filtered out, thereby reducing the number of attributes to be examined. Other characteristics or criteria might also be used to filter or otherwise prioritize attributes for evaluation.

Flowing next to block 608, the remaining attributes and their related feature measure values are used to create a plurality of attribute vectors with associated feature measure results. The vectors and associated feature measure results are then used at block 610 to initialize a tree root node with measure distributions for the target user group and for the control user group.

In one embodiment, a target distribution of the feature measure results is created based on all of the users in the target user group without respect to a given message or user attribute (other than membership in the target user group). The target distribution is then generated based on the percentage of users having a given feature measure result. In one embodiment, the percentage of users might represent values along a y-axis, while the feature measure values are plotted along an x-axis. Similarly, a control distribution for the feature measure results may be created based on all users in the control user group. Thus, the root node for the tree has associated with it, two distributions for the feature measure results, one for the target user group, the other for the control user group.

Processing next flows to a decision block 612, where a determination is made whether a split criteria is satisfied. The intent of this evaluation is directed towards ensuring that a sufficient number of samples are available in both the target user group and the control user group to provide reasonable estimates of parameters usable in computing information gains. In one embodiment, it is desirable to have at least 1000 users in the target user group and at least 1000 users in the control user group. However, other values may also be used. In any event, at decision block 612, if it is determined that an insufficient number of users are in the groups, then process 600 flows to block 614, where tree splitting for this branch is stopped, and the resulting node is deemed a leaf. Thus, in one embodiment, a node having less than the selected minimum sample size for both user groups will not split further until enough users fall into that node's targeting container. Processing would then flow to decision block 624.

Otherwise, if it is determined that a selected minimum sample size for both user groups is satisfied, then processing continues to block 616. At block 616, the information gains of splits for available attributes are computed. As an initial step the estimates for parameters of the feature measure distributions for the target and control user groups at the current node are computed, so as to compute the related entropies. This is because such entropies may be modeled as a function of distribution parameters for the feature measure.

For example, it is determined that for an ARPU feature measure, the distributions may be modeled effectively by Gamma distributions. Gamma distributions may be modeled using a shape parameter k and a scale parameter θ. Any of a variety of approaches may be used to estimate these parameters, including, but not limited to using iterative procedures to estimate k, fit methods, the Choi-Wette method, or the like.

At each leaf node, for each candidate attribute in the message/user attribute vectors and for each attribute split point, the parameters of the conditional Gamma distribution is computed, where the conditional variable may be the candidate split. Furthermore, computations are performed for both the target user group and the control user group, resulting in a set of conditional parameters (kₜ,θₜ,k_{c},θ_{c}|aᵢⱼ), where subscript “t” indicates parameters from the target user group, and “c” indicates parameters from the control user group.

The contribution to the entropy of the feature measure lift for controls and target user groups is then the difference between the feature measure, such as ARPU, of the target and control groups (Rₜ and R_{c}, respectively). Since the feature measure results (e.g. ARPU results) of targets and controls are independent, the entropy of the lift is the weighted sum of the entropies of each group, or:

Hₙ(R)=Hₙ(Rₜ−R_{c})=wₜHₙ(Rₜ)+w_{c}Hₙ(R_{c}),

where the weights wₜ and w_{c} indicate the target/control user group allocation proportions. The entropy of a Gamma random variables has an explicit form of:

Hₙ(Rₜ)=kₜ+lnθₜ+ln Γ(kₜ)+(1−kₜ)ψ(kₜ),

where Γ(•) is the gamma function and ψ(•) is the digamma function In the same way, Hₗ(R_{c}) for the control group can be computed.

The respective conditional entropies Hₙ(Rₜ|aᵢⱼ) and Hₙ(R_{c}|aᵢⱼ) are computed in the same way, but first the corresponding Gamma parameters are computed from the conditional populations in the candidate sub-nodes, from (kₜ,θₜ,k_{c},θ_{c}|Aᵢ=aᵢⱼ) and from (kₜ,θₜ,k_{c},θ_{c}|Aᵢ≠aᵢⱼ).

Moving next to block 618, a determination is made at the current node n the attribute split pair that maximizes the information gain. At a given node n, there will be a total of Nₙ=N_{A}_{₂}+N_{A}_{_{z}}+ . . . N_{A}_{₁} information gain values, one for each candidate attribute/split value, where N_{A}_{ᵢ} is the number of possible splits for attribute Aᵢ.

At block 618, the attribute/split combination that corresponds to the maximum gain is then selected as:

a*n=argmaxₐ_{ᵢⱼ}Gₙ(aᵢⱼ),

where the information gain in terms of its target and control components is written as:

Gₙ(aᵢⱼ)=wₜ[Hₙ(Rₜ)−[w₁Hₙ(Rₜ|Aᵢ=aᵢⱼ)+w₂Hₙ(Rₜ|Aᵢ≠aᵢⱼ)]]+w_{c}[Hₙ(R_{c})−[w₁Hₙ(R_{c}|Aᵢ=aᵢⱼ)+w₂Hₙ(R_{c}|Aᵢ≠aᵢⱼ)]],

and similarly for ordinal and continuous attributes. If this maximum information gain is negative however, then we don't split on any attribute at all. In that case, the node will become a leaf in the tree. Splits only occur for positive information gains.

While the above works well using a gamma distribution model for some feature measures, such as the ARPU feature measure, this may not be the case for other feature measures. For example, ABP distributions might be better modeled using Bernoulli distributions, where the rate of actives may be of interest. Parameters for the Bernoulli distributions include actual active base proportions at node n for the target and control user groups, p_{T}_{ₙ}, p_{C}_{ₙ}, where:

$${p}_{{T}_{n}} = \frac{{T}_{n}^{( active )}}{{T}_{n}} , \\ {p}_{{C}_{n}} = \frac{{C}_{n}^{( active )}}{{C}_{n}} ,$$

The binomial parameters conditioned on the attribute split aᵢⱼ are also similarly calculated.

Similar to the discussions above for ARPU lift, with the same recognition about independence of the target and control sample, the entropy for a Bernoulli distribution may be determined as:

Hₙ(BT)=p_{T}_{ₙ} log₂p_{T}_{ₙ}+(1−p_{T}_{ₙ})log₂(1−p_{T}_{ₙ})

For the control group, and for the conditional entropies, the expressions are identical, and so is the expression for the information gain G(aᵢⱼ), therefore the attribute split that generates the maximum information gain may be selected.

The identified attribute split is then used at block 620 to update the remaining available attributes in the message/user attribute vectors.

If the attribute split is on a categorical attribute, then that attribute is removed from further consideration on the “true” branch. Along the false branch, it is still considered for further splits. Example: say we have a split on PlanID=12. Then for the “true” branch (where every vector has PlanID=12) there is no need to further consider splits on PlanID there since all vectors have the same value. On the false branch however (where every vector has PlanID≠12), vectors may have different values for PlanID so this attribute is still considered for splits.

If the attribute split is on a continuous attribute, then it will still be considered further in both the “true” and “false” branches. Example: say we have a split on Age<=40. On the true branch we have only vectors with Age<=40 so a further split on Age<=20 is possible. On the false branch, we have only vectors with Age>40 so a further split on Age<=60 is possible.

Moving to block 622, the tree is updated with the new node split along with the related distributions for the target and control user groups. The branch is activated, for further evaluations, and processing flows to decision block 624.

At decision block 624, a determination is made whether to continue to train/re-train the tree. For example, where no more attributes are available to evaluate for possible branch splitting, then the tree may be considered to be completed. Other criteria might also be included to terminate tree training. In any event, if the tree is considered to be completed, processing returns to a calling process; otherwise, processing might return to decision block 612, to evaluate another node for another possible branch split.

At this juncture, the training of one or more trees may be complete. That is, a different tree might be created for each of a plurality of different feature measures. For example, one tree might be created (trained/re-trained) for the feature measure ARPU, while another tree might be created (trained/re-trained) for the feature measure ABP. Still other feature measures might result in still other trees.

Moreover, the trees might be re-trained based on any of a variety of criteria, including, but not limited to seeking to include another attribute for a message and/or user, or to take into account changes over time in the response of the feature measure to the marketing offers or the like.

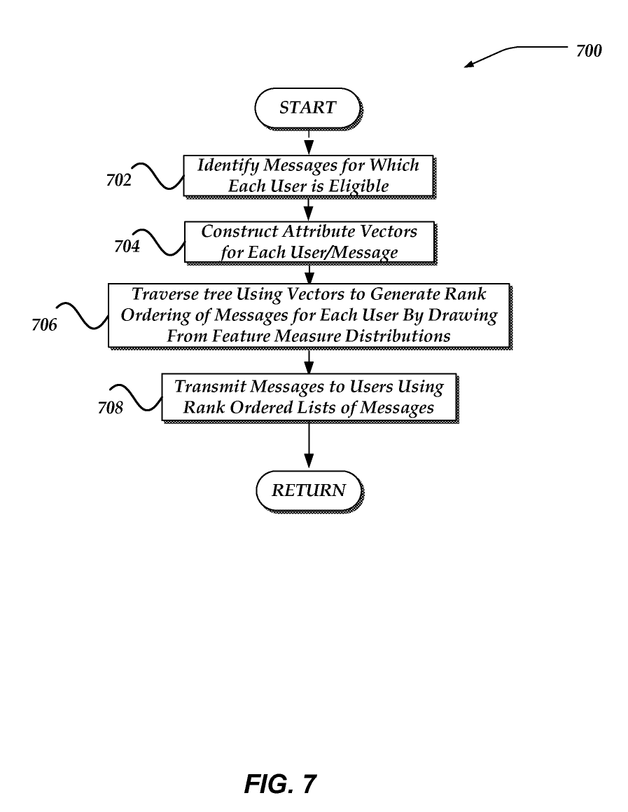

At any time that a tree is completed, it may be used during run-time process 700 of FIG. 7 to determine which message or messages to send to a particular user. Thus, FIG. 7 shows one embodiment of a flow diagram of a process for using the trained tree of FIGS. 5-6 to perform automated marketing offer decisioning.

Run-time process of process 700 begins at block 702, where a set of marketing messages are identified for which each user in a plurality of users is eligible. The plurality of users may include at least some of the target/control users, although it need not. The plurality of users may be selected based on any of a variety of criteria, including based on sub-dividing a marketer's customer base into various geographic segments, or the like. In some embodiments, a marketer may wish to send at least one message to every customer in their customer data base. Thus, the plurality of users might include all customers of a particular telecommunications' service provider, or the like.

In any event, not every user might be eligible for every marketing message in the set of marketing messages that a marketer may wish to send. For example, a message in the set of marketing messages might be intended for users with a particular type of product or service. Thus, users that have the particular type of product or service will be eligible to receive the marketing message, while others would not be eligible. Once each marketing message for which a user is eligible to receive has been identified, processing flows to block 7044.

At block 704, vectors for marketing messages and user attributes are constructed. In one embodiment, the attributes may be concatenated in a same order as that used for the training vectors. Thus, if a user is eligible for 1000 possible marketing messages, a 1000 marketing message/user attribute vectors may be constructed for that user. Similarly, for each other users, a plurality of marketing message/user attribute vectors are constructed.

It should be noted that for any of a variety of reasons, one or more attributes might be missing. This may arise, for example, where a new attribute is added to a marketing message, where a new set of users are included with new attributes, or the like. In these instances, then some other marketing messages or user might not have the new attributes. Several approaches are considered that address this situation. For example, for categorical attributes, a new category of NULL might be treated as any other category. For ordinal attributes, every time a split is evaluated, instead of evaluating only one test, the following tests might be evaluated:

Aᵢ≦aᵢⱼ OR Aᵢ=NULL vs. Aᵢ>aᵢⱼ,

Aᵢ≦aᵢⱼ vs. Aᵢ>aᵢⱼ OR Aᵢ=NULL, and

Aᵢ=NULL vs. Aᵢ≠NULL

If there are Sᵢ candidate splits for attribute Aᵢ, then there are 2*Sᵢ+1 information gain calculations. While this approach may require more time to train take longer to train the tree (missing attributes may arise during training of the tree as well as during run-time), but conceptually nothing changes, and at each node the split point that produces the maximum information gain may still be selected.

Continuing to block 706, then for each attribute vector for each user, the tree with the feature measure of interest is traversed to generate a rank ordering of marketing messages for the user. When the tree has been traversed to a node within the tree based on matching of attribute values in a user's vector with the tree node values. At that node, a random drawing is performed from the target distribution and the control distributions to obtain an expected lift as a difference between the randomly drawn values. This is performed for each marketing message for the user, to generate a listing of sampled expected lifts for each marketing message that the user is eligible. The marketing messages may then be rank ordered based on the determined sampled lift values for each marketing message. This block is performed for each user, for each message for that user, to generate rank orderings of marketing messages for each user. By selecting randomly from the target and control distributions it may be possible to generate different rank orderings of marketing messages and thereby enable an exploration and exploitation approach to providing marketing messages, and thereby potentially improve upon the results for the feature measure of interest.

It should be noted that the above can readily be adapted for situations where there is a desire to blend decisions for sending messages that seek to benefit from several feature measures. For example, using an ARPU generated tree, and an ABP generated tree, results of the two may be combined.

In one embodiment, the output from the ARPU sample values of the percent lift may be normalized to the population percent rather than the control. That is:

ABP_% Lift=(ABP_Target_Treatment_Sample−ABP_Control_Treatment_Sample)/Population_ABP

ARPU % Lift=(ARPU_Target_Treatment_Sample−ARPU_Control_Treatment_Sample)/Population_ARPU

In another embodiment, both trees may be walked to obtain sampled lift percentages, which may be added together in a weighted approach to generate the rank ordered list of marketing messages. One approach for a combined lift is:

combined lift=q₁ ABP % Lift+(1−q₁)ARPU % Lift

This approach can be extended to many trees, with Σᵢqᵢ=1.

In any event, moving to block 708, the rank ordered list of marketing messages for each user may then be used to selectively transmit zero or more marketing messages to a user. For example, a threshold value might be used where marketing messages having a determined lift is below that threshold might not be sent. In another embodiment, a first marketing message on each list for each user might be sent to that user, independent of its associated lift.

Run-time process 700 then may return to a calling process.

It will be understood that each block of the flowcharts, and combinations of blocks in the flowcharts, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multi-processor computer system. In addition, one or more blocks or combinations of blocks in the illustration may also be performed concurrently with other blocks or combinations of blocks, or even in a different sequence than illustrated without departing from the scope or spirit of the subject innovation.

Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware based systems, which perform the specified actions or steps, or combinations of special purpose hardware and computer instructions.

### Illustrated Non-Limiting, Non-Exhaustive Examples

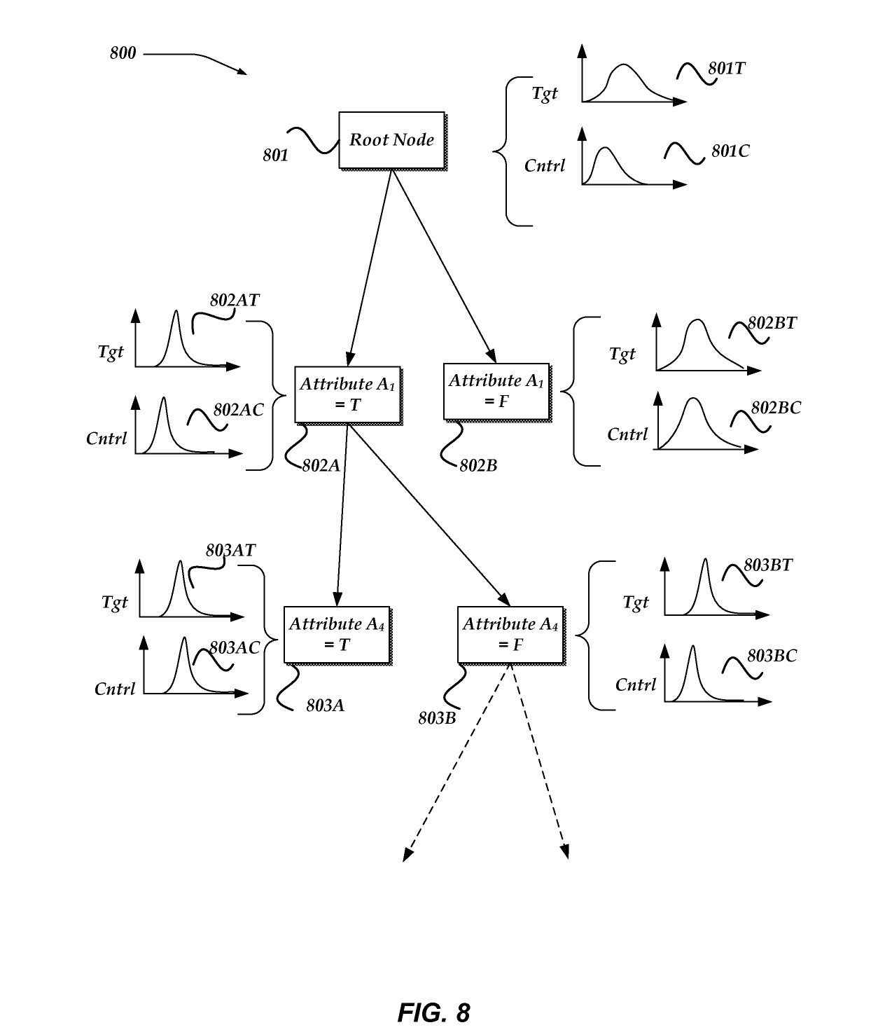

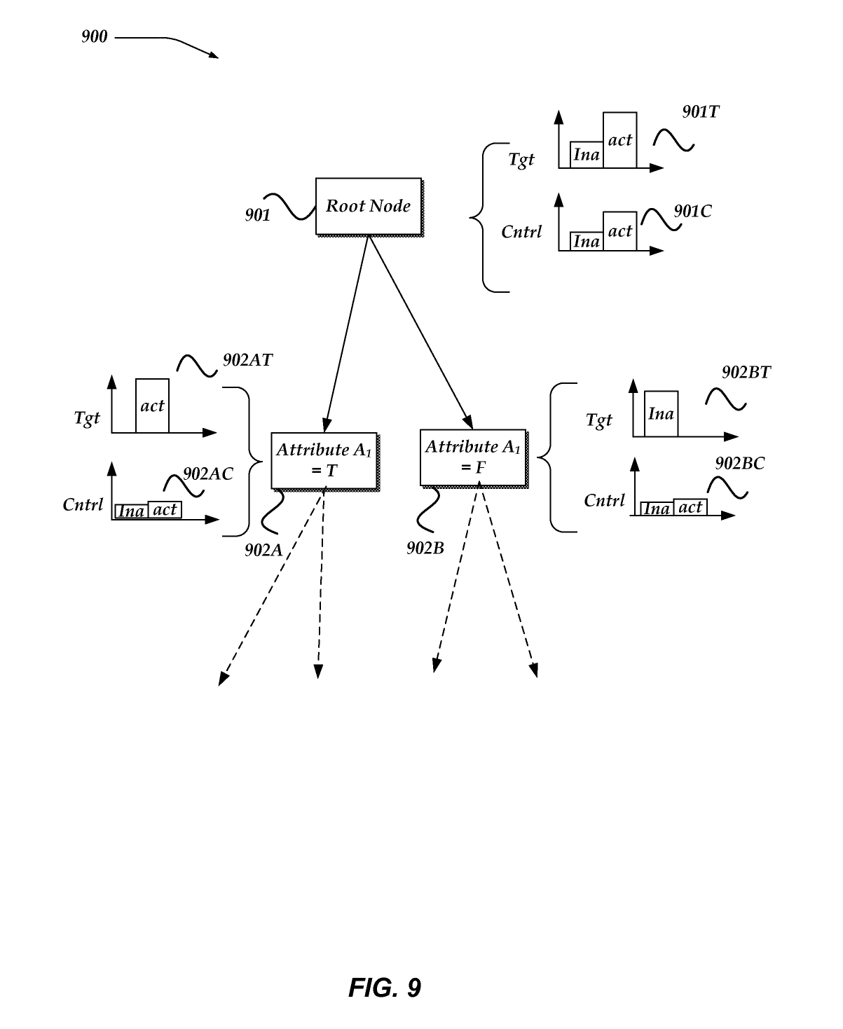

The following provides non-limiting, non-exhaustive examples of how various embodiments might be employed to provide contextual offerings to a customer using trees having feature measure distributions. FIGS. 8-9 illustrate non-limiting, non-exhaustive examples of subsets of trees with different feature measure distributions. Thus, for example, FIG. 8 might illustrate nodes on a tree with ARPU feature measure distributions.

For example, tree 800 includes nodes 801, 802A, 802B, 803A, and 803B. Each node in tree 800 includes a target (tgt) distribution and a control (contrl) distribution (801T, 801C, 802AT, 802AC, 802BT, 802BC, 803AT, 803AC, 803BT, or 803BC). It should be noted that tree 800 is merely an example, and as such, other configuration are possible, and the subject innovations are therefore not constrained by this example.

In any event, during training, as described above, in conjunction with FIG. 5, the root node 801 may be identified with tgt and contrl distributions, 801T and 801C, respectively. As shown, the y-axis for the illustrated distributions may be percentage of users, while the x-axis may be an ARPU value. As discussed above, the distributions are generated by taking each user in the target user group and each user in the control user group and mapping their ARPUs onto the respective graphs.

Moving to the next nodes (802A and 802B), these nodes were identified based on that attribute in the message/user attribute vectors that maximize the information gain. For example, each attribute in the vector or message and user attributes is evaluated to compute a respective information gain, as discussed above in conjunction with FIG. 6. That attribute that provides the maximize information gain is then selected to be the attribute that generates nodes (802A/B), aka, creates a branch split. Those users in the target user group and control user group are then used to generate the respective distributions for the binary values of the splitting attribute (e.g., A1). See distributions 802AT, 802AC for one value of attribute A1, and 802BT and 802BC for the other value of attribute A1.

Each node 802A and 802B may similarly be examined to determine whether a message/user attribute vector is available that provides a maximum information gain. For this non-limiting example, node 802B, it might be determined that none of the remaining attributes (having removed attribute A1 from the vector under evaluation) provides a maximum information gain. Similarly, it might be determined that for node 802B, the user groups have insufficient sample sizes. Thus, no further split evaluations are shown below node 802B.

However, for node 802A, attribute A4 might have been determined to maximize the information gain. Thus, nodes 803A and 803B might be created as splits for the attribute A4 below node 802A. Similarly, distributions are associated with each of these new nodes. Processing may then continue as discussed above until the tree is considered complete.

At run-time, a plurality of messages is used to generate a plurality of message/user attribute vectors for each user. Then, each vector is examined to traverse tree 800. Thus, for example, the message/user attribute vector is examined to determine a path based on the value of A1, A4, and so forth. Assuming, for example, that node 803A ends the traversal for a particular message/user attribute vector. Then, a value is randomly drawn from target distribution 803AT and a value is randomly drawn from control distribution 803AC. The combination of these values provides a lift value for this message for this particular user. Similarly, values may also be obtained for other messages for this particular user. The values obtained for the list of messages may then be rank ordered and the ordered list may subsequently be used to transmit zero or more messages to a user.

FIG. 9 illustrates a non-limiting, non-exhaustive example of tree 900 with a binary feature measure distribution. In one embodiment, tree 900 might represent a tree developed for an ABP feature measure distribution. Tree 900 is shown having root node 901, and nodes 902A and 902B, where each node is associated with a target feature measure distribution and a control feature measure distribution. See distributions, 901T, 901C, 902AT, 902AC, 902BT, and 902BC. As shown, the y-axis for the distributions represents a population percentage, and the x-axis represents active or inactive base after a defined time period. Creation and usage of tree 900 employs processes 500 and 600 as described above.

The above specification, examples, and data provide a complete description of the manufacture and use of the composition of the subject innovation. Since many embodiments of the subject innovation can be made without departing from the spirit and scope of the subject innovation, the subject innovation resides in the claims hereinafter appended.

1-28. (canceled)

29. A non-transitory computer-readable storage device having instructions stored thereon that, in response to execution by a processor unit, cause the processor unit to perform operations, the operations comprising:
configuring, by the processor unit, a decisioning device of a service provider to store a created tree data structure representing groupings of users that share attributes corresponding to use of services provided by the service provider, wherein the tree data structure has multiple branches and multiple nodes in which each of the branches is associated with an attribute and in which each of the nodes is associated with a separate subset of users from a plurality of users in a target user group, and wherein each node includes a target distribution for the users in the associated subset of users based on a feature measure that corresponds to user responses to a plurality of sent training messages and further includes a control distribution based on the feature measure for other users in a control user group;
using, by the processor unit, the stored tree data structure on the configured decisioning device to send a plurality of further messages to multiple additional users distinct from the plurality of users in the target user group, including, for each of the multiple additional users, traversing the stored tree data structure based at least in part on attributes of the additional user, generating an ordered ranking for the additional user of the plurality of further messages based on determining a feature measure lift by performing a comparison between randomly selected values from the target and control distributions in the nodes of the stored tree data structure, and using the ordered ranking to select one or more messages of the plurality of further messages to send to the additional user;
adapting, by the processor unit, the stored tree data structure to changes over time by changing the branches and the nodes of the tree, and updating the configured decisioning device based on the adapted stored tree data structure, including, for one or more additional times after the using of the stored tree data structure to send the plurality of further messages, retraining the stored tree data structure to correspond to further user responses to additional interactions with respect to the feature measure; and
after the one or more additional times, using, by the processor unit, the adapted tree data structure to select and send additional messages to users.

30. The non-transitory computer-readable storage device of claim 29 wherein the stored instructions further cause the processor unit to create and train the tree data structure, including to send the plurality of training messages and to receive the user responses, wherein the plurality of training messages have a plurality of attributes and are sent to the plurality of users, and further including to create the branches to each maximize an information gain for the attribute associated with the branch, and determining an information gain for each node within the tree data structure based on a difference between an overall entropy at the node and an entropy conditioned on a candidate attribute at the node.

31. The non-transitory computer-readable storage device of claim 30 wherein the stored instructions cause the processor unit to further perform operations including performing pre-processing on at least one message attribute or user attribute to enable binary testing to be performed using the at least one message attribute or user attribute during creating and training of the tree data structure.

32. The non-transitory computer-readable storage device of claim 30 wherein creating and training of the tree data structure includes measuring results for the feature measure for each of the plurality of users in the target user group and each of the other users in the control user group based on the sending of the plurality of training messages, and includes performing the training based on the measured results for the feature measure.

33. The non-transitory computer-readable storage device of claim 32 wherein the creating and training of the tree data structure is further performed for each of a plurality of feature measures to generate and train a plurality of tree data structures that are each specific to one of the plurality of feature measures, and wherein the sending of the plurality of further messages further includes, for each of the multiple additional users, traversing the plurality of tree data structures, and combining a corresponding plurality of feature measure lifts to generate the ordered ranking for the additional user.

34. The non-transitory computer-readable storage device of claim 29 wherein the adapting of the tree data structure to the changes over time includes, during the using of the stored tree data structure, performing random selecting of values from the target and control distributions for the nodes of the tree data structure to explore and exploit variations in responses to the plurality of further messages, and includes tracking the responses to the plurality of further messages and using the tracked responses as some or all of the additional interactions for at least one of the additional times to improve the retrained tree data structure for the at least one additional time.

35. The non-transitory computer-readable storage device of claim 29 wherein the adapting of the tree data structure to the changes over time includes, after the using of the stored tree data structure, performing further experiments involving further sent training messages and tracking user responses to the further sent training messages, and includes using the tracked user responses as some or all of the additional interactions for at least one of the additional times to improve the retrained tree data structure for the at least one additional time.

36. The non-transitory computer-readable storage device of claim 29 wherein the changing of the branches of the tree data structure during the adapting of the tree data structure to the changes over time includes adding one or more new branches and adding multiple new nodes to the tree data structure, and wherein the using of the adapted tree data structure is based at least in part on the added one or more new branches and added multiple new nodes.

37. The non-transitory computer-readable storage device of claim 29 wherein the changing of the nodes of the tree data structure during the adapting of the tree data structure to the changes over time includes modifying at least one of the target distribution or the control distribution for each of one or more nodes of the tree data structure, and wherein the using of the adapted tree data structure is based at least in part on the modified at least one target distribution or control distribution for each of the one or more nodes.

38. The non-transitory computer-readable storage device of claim 29 wherein the adapting of the stored tree data structure to the changes over time is performed for each of multiple additional times using a sliding time window that includes at least some data distinct from data used for initial creating and training of the stored tree data structure.

39. The non-transitory computer-readable storage device of claim 38 wherein a duration of the sliding time window is adaptive based on a user behavior.

40. A network device, comprising:
a transceiver to send and receive data over a network; and
one or more processors that are operative to perform actions, including:
configuring a decisioning device of a service provider to store a created model with a tree data structure that has multiple groups of users each having common user and message attributes, including sending a plurality of training messages to a plurality of users in a target user group and separating the plurality of users into the multiple groups of users to maximize an information gain for a message attribute or user attribute with respect to a feature measure, wherein each group of users has an associated node in the created model with a target distribution for the users in the group based on the feature measure and with a control distribution for other users in a control user group based on the feature measure;
using the created model with the tree data structure to send a plurality of further messages to multiple additional users distinct from the plurality of users in the target user group, including, for each of the multiple additional users, employing the created model with the tree data structure to generate an ordered ranking for the additional user of the plurality of further messages based on determining a feature measure lift, and using the ordered ranking to select one or more messages of the plurality of further messages to send to the additional user;
adapting the created model with the tree data structure to changes over time by, for each of multiple additional times after the using of the created model with the tree data structure to send the plurality of messages, retraining the model with the tree data structure for the additional time to correspond to further user responses to additional interactions with respect to the feature measure, wherein the adapting includes modifying at least one of the target distribution or the control distribution for each of one or more nodes in the created model for one or more of the groups of users; and
after each of one or more of the multiple additional times, using the adapted model for the additional time to select and send additional messages to users.

41. The network device of claim 40 wherein the adapting of the model for at least one of the additional times further includes adding at least one new group of users to the model.

42. The network device of claim 40 wherein the model further includes one of a logistic regression model, neural network, support vector machine regression, Gaussian process regression, or Generalized Bayesian model.

43. The network device of claim 40 wherein at least one of the multiple groups of users includes users having a common user attribute that represents a user propensity, and wherein at least one of the multiple groups of users includes users having a common user attribute that represents a usage histogram cluster.

44. The network device of claim 40 wherein at least one of the multiple groups of users includes users having a common user attribute that represents a recharge time series.

45. The network device of claim 40 wherein the separating of the plurality of users into the multiple groups of users to maximize the information gain is performed based on maximizing a difference between an overall entropy at a first decision point and an entropy conditioned on a candidate attribute at the first decision point.

46. A network device, comprising:
a transceiver to send and receive data over a network; and
one or more processors that are operative to perform actions for a service provider, including:
configuring a decisioning device of the service provider to store a created new tree data structure representing groupings of users that share one or more attributes related to providing user responses, wherein the tree data structure has multiple branches and multiple nodes in which each of the branches is associated with an indicated attribute that is a message attribute or a user attribute and in which each of the nodes is associated with a separate group of users that is a subset of a plurality of telecom subscriber users, wherein creating and training of the tree data structure includes creating the branches to each maximize an information gain for the indicated attribute associated with the branch and with respect to a feature measure based on responses of the plurality of telecom subscriber users to a plurality of sent training messages having attributes corresponding to being sent at different times and with different types of messages, and wherein each node includes a target distribution based on the feature measure for the users in the group associated with the node and includes a control distribution based on the feature measure for other users in a control user group;
using the stored tree data structure on the configured decisioning device to send, to an additional telecom subscriber user that is distinct from the plurality of telecom subscriber users and that has identified attributes based at least in part in prior activities in using telecom services, one or more further messages by traversing the stored tree data structure based at least in part on the identified attributes, generating an ordered ranking for the additional telecom subscriber user of the plurality of further messages based on determining a feature measure lift by selecting values from the target and control distributions in the nodes of the tree, and using the ordered ranking to select the one or more further messages from the plurality of further messages;
adapting the stored tree data structure to changes over time by changing the branches and the nodes of the tree, and updating the configured decisioning device based on the adapted stored tree data structure, including, for each of multiple additional times after the using of the stored tree data structure to send the one or more further messages, retraining the stored tree data structure for the additional time to correspond to further user responses to additional interactions with respect to the feature measure; and
after each of one or more of the additional times, using the adapted tree data structure stored on the updated configured decisioning device to select and send additional messages to users.

47. The network device of claim 46 wherein the feature measure includes at least one of an Average Revenue Per User (ARPU), Active Base Percentage (ABP), Average Revenue Per Paying User (ARPPU), or an average margin per user (AMPU).

48. The network device of claim 46 wherein the creating and training of the tree data structure includes creating a NULL category and performing testing based on the NULL category using one or more of the plurality of sent training messages for which at least one message attribute or user attribute is missing.
